(19) United States
(12) Patent Application Publication
(10) Pub. No.: US 2021/0354080 A1
(43) Pub. Date: Nov. 18, 2021

(54) Air Humidity Condensing and Potabilizing Machine

(71) Applicant: Water Global Solutions, S.L., Maddrid (ES)

(72) Inventors: Francisco Javier Sanchez Alejo, Madrid (ES); Mario Errejon Lopez, Madrid (ES); Alberto Sanz Cuenza, Madrid (ES); Raul De La Fuente Villanueva, Madrid (ES); Jorge Montoya Benito, Madrid (ES)

(21) Appl. No.: 16/886,595

(22) Filed: May 28, 2020

(30) Foreign Application Priority Data
May 14, 2020 (ES) 202030448

(51) Int. Cl. B01D 53/26; F24F 3/14; F24F 13/22; C02F 9/00; C02F 1/16; C02F 1/00; E03B 3/28

(52) U.S. Cl. CPC B01D 53/265; F24F 3/1405; F24F 13/22; C02F 9/00; C02F 1/68; C02F 1/008; E03B 3/28; F24F 2003/1446; F24F 2013/228; C02F 1/16

(57) ABSTRACT

Air humidity condensing and potabilizing machine consisting of a compression thermodynamic cycle with forced ventilation so that the ambient air with a certain temperature and humidity is forced to pass through a compression evaporator whose walls are cold, and on which a percentage of its humidity is condensed, this water being collected and sent to a double purification circuit with sediment filters, ultraviolet lamps, carbon filter and mineralization to adapt it to human consumption, the machine having different systems that optimize the production of water to reduce its energy and economic cost, as well as devices to improve the quality of the air entering the machine and the water obtained in different environments and circumstances of use.

### OBJECT OF THE INVENTION AND SECTOR OF THE ART

The present invention relates to a machine for condensing the relative humidity of the air by means of a thermodynamic cycle with improved efficiency and effectiveness, which has a system for potabilizing both condensed water and rainwater collected and water from contaminated sources.

This invention mainly pertains, within the field of industrial facilities for obtaining and potabilizing water, to the equipment that obtains water through the condensation of air humidity.

### BACKGROUND OF THE INVENTION

Obtaining drinking water in the right quantity, quality and price for human consumption is an increasingly important problem, since overpopulation means that traditional sources are insufficient today, and due to the proliferation of human and industrial activities, which have contaminated rivers and aquifers that once had salubrious characteristics but are today unfit for human consumption.

Thus, for years now, new sources of drinking water and new methods of potabilizing contaminated waters have been sought, with the attention having been turned towards an immense source of drinking water in the form of gas or steam, which is the humidity in the air. The sun evaporates all kinds of water, from the brackish sea water to the polluted waters found in all kinds of sources, and that is the best possible potabilization process, since the evaporated water molecules leave down the physical, chemical and biological pollutants that the source might contain.

In this way, the task pending would be to condense this water to obtain a pure liquid, but in its process of condensation and storage, new sources of contamination may appear, although of a very limited type, so once condensed it is necessary to subject it to a new purification process before being consumed, as well as adding the mineral salts that it does not contain and that are beneficial to health.

Psychrometry is the branch of science that studies the thermodynamic properties of moist air and its effect on materials and human comfort. Psychrometric diagrams that establish the amount of water vapour that the air can contain based on its temperature and pressure have been known for many years. These diagrams also establish the dew point or temperature at which a surface must be in order for air humidity to start condensing on it.

In this regard it is commonly known that, for example, on the evaporators of air conditioners a portion of the humidity of the air that passes through them condenses, making it necessary to evacuate this water collected into drains or containers.

In environments where humidity is a problem, dehumidifying equipment is used to dry the air, many of which are basically compression thermodynamic cycles, similar to an air conditioning device, in which the air in the room is passed through the refrigerated evaporator and leaves the machine in a drier state than it entered, and the condensed water is collected in a tank.

Simple machines for obtaining drinking water through the condensation of air humidity, therefore, lack novelty and inventive step today, but their use is severely restricted due to the high energy and economic cost of the litre of water obtained this way, which cannot generally compete with other methods of obtaining or purifying drinking water, such as reverse osmosis or ultrafiltration systems.

To make these machines profitable it is necessary to introduce technical improvements that solve the problems they currently have, going beyond some traditional ways of working in the sector and overcoming some technical prejudices observed in the equipment existing today.

One of them is undoubtedly the high by-pass factor or proportion of humidity in the air that passes through the evaporator without having come into contact with the cold surfaces of its plates or fins and, therefore, without having condensed. To try to solve this, it is possible to use condensers with very close plates, but in this case the problem is that the aerodynamic load loss is very significant, even leading to the paradox that the condensed water drop itself becomes an obstacle to the passage of humid air, not to mention that it will be easier for the condenser to become clogged with dirt that completely prevents the passage of air.

In addition, the most effective condensation systems soon begin to lose efficiency due to the amount of water they contain, mainly at their lower part: the fact that the plates and tubes of an evaporator are waterlogged is a real problem, since besides the water drops hindering the passage of air by occupying a significant space between adjacent plates, the drop is hotter than the plate and makes the micro-condensation of new water vapour difficult. To try to solve this, manufacturers provide the plates with a water-resistant coating that facilitates the drop falling towards the lower part where the condensed water is collected, but this is insufficient, and numerous laboratory tests show how the lower part of evaporators are virtually incapable of condensing water because they are waterlogged, which drastically reduces the machine efficiency.

On the other hand, condensed water in thermodynamic cycles has long been considered an undesirable waste that is disposed of, so its quality has not been taken into account. However, in condensing machines intended for the potabilization of the water obtained fundamental factors of cleanliness and sanitation of the water obtained come into play, so it is essential to thoroughly clean the parts of the machine with which the water comes into contact, such as the evaporator, this cleaning often consisting in immersing these components in liquids in order to disinfect any type of bacteria and viruses that may be present, and in the removal of substances or residues that over time may have adhered to the plates and tubes. In this way, and having demonstrated that the mere spraying or projection of these liquids is not sufficient for their thorough cleaning, the immersion of the evaporator in these disinfecting and descaling liquids is currently impossible, since the front and rear openings for the passage of air prevent its volumetric confinement, making it also impossible to dismantle the evaporator since the pipes that supply it with refrigerant gas or heat-transfer fluid are always fixed, usually copper pipes welded between the plates of the evaporator.

Another issue that has not been addressed to date by manufacturers of air humidity condensing and potabilizing machines is that, although the water obtained is very pure. in environments with polluted air, as in large cities, it may contain some pollutants such as suspended substances and dissolved gases such as CO₂. Large suspended substances do not normally pose a problem as they are relatively easily removed with filters and membranes, but finer particles, such as those produced by internal combustion engines, pass through them with ease and eventually end up in the water we will drink, as they cannot be filtered out by the finest commercial water filters either.

But undoubtedly current systems are even more ineffective at removing dissolved gases. The most common effect of dissolved carbon dioxide is to obtain acidified water with high conductivity, which can make it undrinkable. There are various methods on the market to eliminate CO2 in water, such as the use of limestone substances that cause the decantation of carbonates and bicarbonates, the use of very low porosity membrane contactors, etc., all of them are efficient methods designed for in-line production, but are not suitable for atmospheric condensation equipment and with small productions of drinking water.

On the other hand, the absorption refrigeration cycle, although of worse performance than the compression cycle, is sometimes used when a cheap heat source is available, such as solar thermal panels, but its use entails great disadvantages for the industrial production of condensed water, such as the slow cooling of the evaporator, temperature that sometimes does not reach the dew point of the air humidity, operation and performance conditioned by the amount of heat or by the lighting conditions of the day if solar thermal panels are used, or the like. For these reasons there is no known absorption cycle for condensing air humidity and there is common agreement in the scientific community that these cycles are completely ineffective for dehumidifying spaces.

Other inadequacy of the currently existing water condensing and potabilizing machines is that manufacturers fail to understand that, synergistically, these machines could meet the supply of more drinking water very cheaply with other water sources, since our studies have revealed that:
Rainwater has very similar physical-chemical and biological characteristics to condensed water, so the water potabilization system is identical, and obtaining it is much cheaper in terms of energy, since the condensation process consumes much more energy than the water potabilization process.
These machines or equipment must be located in inhabited areas where there are usually sources of water, although with a large number of pollutants that make it unhealthy, and the thermodynamic compression cycle generates an enormous amount of residual heat that is evacuated through the air and is not used in any way. This heat could undoubtedly be used to evaporate contaminated water, resulting in this water being distilled and accumulated in the machine internal tank, since the water thus obtained also has very similar physical-chemical and biological characteristics to those of condensed water,

There are some equipment driven by compression thermodynamic cycles intended for the condensation of air humidity, which have been protected by patent, and the International Patent Classification mainly include them under headings E03B 3/28 (Installations or methods for obtaining, collecting or distributing water from humid air) and B01D 5/00 (Physical or chemical processes or apparatus in general for the condensation of vapours), although others, without being protected by industrial property titles, are listed in commercial catalogues and can be purchased from specialized suppliers. Another heading under which patents that could be related to some of the technical improvements described herein is the F24F 3/14 (air dehumidification for air conditioning).

None of the sources consulted has shown any equipment for condensing and potabilizing air humidity with technical improvements such as those described below, nor any solution to effectively improve the problems described herein.

There are some patents and utility models for simple condensation of air humidity. For example, the Spanish utility model U200800582 describes truck-transportable equipment for obtaining water from air humidity. The European patent with international extension PCT/ES2005/000471 “Method of obtaining water from an atmospheric air mass and machine for obtaining water by condensing the moisture from an air mass” describes a device with similar characteristics, although the EIT [state of the art report] shows that its claims are anticipated by previous documents, such as patent WO 1997016682 A1, “Conditioner with accompanying output of water by condensation of atmospheric moisture”.

These and other references analysed include equipment designed for condensing and potabilizing air humidity, but at no time do they propose technical solutions such as those provided herein to improve their efficiency to the extent necessary to make them economically and energetically profitable, let alone an equipment to accomplish this.

Considering the importance of obtaining drinking water in commercial quantities, some manufacturers of special equipment have in their catalogues industrial devices for the condensation of humidity in the air. After analysing all these equipment, and after using a number of them, it can be stated that none of them makes it possible to obtain water in profitable and competitive conditions with other methods, and that they completely lack the characteristics and advantages of the equipment described herein. In fact, its clear inadequacy to the intended purpose is the origin of the need to carry out the research that has resulted in this invention.

### EXPLANATION OF THE INVENTION

The main purpose of the invention is the realization of an air humidity condensing and potabilizing machine provided with technical improvements compared to the existing ones in order to make it economically feasible and with health guarantees, so that it can be a commercial alternative to the current methods of obtaining drinking and industrial water.

The invention that has been developed to solve the problems described and achieve the objectives set out is a system formed by a thermodynamic cycle with forced ventilation by depression so that the air in the room, with a certain temperature and humidity, is forced to pass through the equipment evaporator, whose walls are cold and on which a percentage of its humidity is condensed. In this way, the air is drier and colder than it was when it entered. After passing through the evaporator, the air passes through the system condenser, where it is heated while the heat-transfer fluid is cooled to allow the thermodynamic cycle to operate and, after passing through the fans, the air coming out of the machine is sent back to the environment, having left much of its humidity in the evaporator.

For its correct operation, and as in most of the thermodynamic cycles with these features, an inverter compressor is placed between the condenser and the evaporator, which moves the heat-transfer fluid, and a lamination valve that enables the evaporation of the fluid, and has an electrical and control system that manages the operation of the equipment. Thus, according to the invention:
under the evaporator there is a water manifold on which the condensed water drops fall, which are sent to a tank by means of a pump, where there is a water purifying and potabilizing system that prepares it for the type of consumption intended.
although condensed water is very pure, in its transit from the evaporator slats and tubes to the collecting tray it may have been mixed with some particles present in the air, so a hydraulic pump will pass it through sediment filters of 20 μm, 10 μm and 5 μm where the largest particles, such as dust, pollen or similar, will remain, as well as through a water disinfection system, such as an ultraviolet light lamp, which will destroy any bacteria, virus, etc. that it may contain. The water thus purified will be stored in an internal tank, for it to be consumed, thus constituting the first water circuit of the machine.
when the consumer turns on the consumption tap, the pressure in the second circuit drops, which is detected by a water pressure sensor, which activates a second hydraulic pump that takes the water from the internal tank and makes it pass through a carbon filter—which eliminates any smell or taste that the water may have acquired while it was in the internal tank—and a mineralizing filter—which adds the minerals necessary for health and those released when it was evaporated by the sun—, as well as by a second ultraviolet light lamp so that it reaches the consumer with the highest physical, chemical, biological and organoleptic quality.
the quantity of mineral salts contained in the water, i.e. its hardness, can be regulated automatically according to the consumer's taste, since a bifurcation or by-pass is placed around the mineralizing filter with a proportional or absolute electrovalve that allows a greater or lesser quantity of water to pass through the mineralizing filter, increasing or decreasing water hardness. Once the mineralizing filter and the by-pass have been passed through, the water from both sides is brought together again and at this point a hardness sensor, electrical conductivity sensor or total dissolved solids (TDS) meter is fitted, which automatically indicates to the by-pass electrovalve the opening ratio that provides the water with correct hardness.
to prevent the second pump from repeatedly running when the consumption tap is turned on, the second water circuit is equipped with a hydro-pneumatic accumulator that maintains the pressure in the circuit and provides it with small quantities of water without the second pump having to be activated.
to keep the water in the tank in perfect condition even during long time periods of non-operation, periodically the second pump will be activated by taking water from the water tank and bringing it back again to the tank after passing through the ultraviolet lamp of circuit 1, so it is periodically in movement, thus being oxygenated and purified in case any bacteria or virus could have reached the internal tank.
in addition, the system is equipped with one or more external tanks that allow it to store more water, these tanks being equipped with their respective hydraulic pumps and level sensors (not shown in the drawings), and have the same features and functionalities as the internal tank, such as recirculation to keep it in optimal conditions for long time periods of non-consumption.
to prevent the largest particles in the air from reaching the evaporator and contaminating the water that has been condensed there, the machine has an air filter, but this filter cannot prevent the smallest particles from passing through it and ending up in the water, with particles larger than 5 μm being retained in the water filters. However, particles smaller than this size will pass through the filters and end up being consumed by the user. To avoid this situation, the equipment has a particle ionizer behind the air filter, which will make even the smallest particles smaller without a loss of aerodynamic load, which would reduce the amount of air entering the machine, and therefore its performance.
the equipment is also fitted with a system for monitoring and reducing the amount of CO₂ dissolved in the condensed water, which consists of a CO₂ sensor that monitors the quality of the humid air entering the machine, sending a signal to the automaton that governs it when it exceeds certain levels considered to be dangerous or harmful, this level having been established at 0.045% or 450 ppm, thanks to the research carried out for the development of this equipment, a level that is still healthy but from which the CO₂ fixation starts to be unacceptable for the developers of the invention. Once this level is reached or exceeded, the automaton orders an increase in the pressure and speed of the hydraulic pump of the first circuit that collects the water from the manifold and stores it in the tank, in such a way that the water is propelled at speeds above 2 m/s before abruptly colliding and bubbling in the storage tank, releasing part of the gases contained in it. In addition, an online pH sensor checks the quality of the water before it is consumed by users, preventing it from being supplied and warning the consumer of the unsuitability of drinking it if it exceeds the limits set as acceptable by the health authorities of each country where the equipment is installed.
in order to thoroughly clean the evaporator by immersion in liquids which will cause the disinfection of any bacteria, viruses and incrustations of substances or residues which may have adhered to the plates and tubes during operation, the evaporator comprises a watertight perimeter enclosure, either fixed or removable, which covers its sides, comprising, at least, a removable bottom watertight lid with means of fixing to the bottom outlet of the evaporator and which completely enclose it, in such a way that all together form a basin or closed container with the only opening at the top, in such a way that the cleaning chemical agent can be poured into the container, with the heat exchanger(s) being completely immersed in it, and these plates or this enclosure can be removed when cleaning is complete. Alternatively, the plates could be replaced by plastic sheets that when joined at the ends form a watertight plastic pouch that holds the heat exchanger(s) inside allowing them to be filled with cleaning chemicals that they are immersed in the pouch.

In this way, the following advantages are achieved:
to obtain highly pure and high quality water, with the most suitable physical, chemical and biological characteristics,
to keep it in perfect storage conditions regardless of how long the stored water may remain unconsumed
to always provide the water with the level of hardness selected by the user, regardless of whether the mineralizing filter is reducing its load.
to make highly filtered air reach the evaporator regardless of the atmospheric conditions in which the machine is placed, with suspended particles of different sizes,
to prevent high concentrations of CO₂ from affecting water quality
to enable periodic thorough cleaning of the evaporator by total immersion in disinfectant and descaling

But in addition to these innovations that make it possible to obtain water of the highest possible quality, the equipment is provided with other innovations that improve its performance and energy efficiency to make it very competitive with respect to other means of water purification. Thus, according to the invention:
the equipment has a particular arrangement of the evaporator plates that are placed to distribute the cold of the tubes through which the Freon passes, consisting of its placement not continuous in all its depth but counterbalanced, which has been designed so that without significantly increasing the loss of aerodynamic load, it divides the air flow that passes between each two sides of the evaporator with the aim of decreasing the “bypass factor”, increasing the percentage of water vapour molecules that collide and condense against the cold walls of the evaporator.
with the same aim, a sinuous “S” shape has been stamped on the end of the evaporator as a drop-breaking profile to create an aerodynamic turbulence that makes a percentage of the remaining water molecules collide with the cold plate, which further increases the efficiency and performance of the evaporator.
in order to remove the drop of water from the evaporator causing it to fall into the collecting tray as quickly as possible and allow air to pass more freely through the evaporator and new water molecules to condense on its slats, it has been fitted with a device that periodically produces a vibration in the evaporator, in such a way that the condensed drops descend faster to the collecting tray. Alternatively, it is possible to install an air compressor that produces short, periodic impulses of pressurised air from the upper part of the evaporator, causing the drop of water to fall faster into the water collection tank, draining the lower part of the evaporator slats in the same way.
as an auxiliary or optional feature, the evaporator of an absorption refrigeration cycle is located between the evaporator and the condenser of the compression refrigeration cycle, so that the machine becomes a hybrid thermodynamic system by compression and absorption. The absorption cycle is prepared to use the heat from some cheap or free source, such as solar thermal panels, which are located near the machine. This combination is very appropriate, since atmospheric humidity condensers are recommended for geographical areas where there is high humidity and temperature, conditions also particularly appropriate for absorption cycles, although the latter could only work during the day. In order to make the hybrid system efficient it was necessary to introduce a control system that manages the alternative or simultaneous startup of each of these thermodynamic cycles based on two groups of parameters:
   a) machine-specific parameters:
      volume of condensed water in the tank, controlled by a liquid level sensor,
      instant demand for water, controlled by the water outlet electrovalve of the tank,
      light on the solar panels, controlled for example by a photometer or luxmeter, or thermometer on the heat source of the absorption thermodynamic cycle condenser, so the controller can calculate the potential for obtaining cold in the absorption evaporator, and how fast the evaporator can reach the dewpoint temperature,
      temperature of the absorption evaporator, to see if its temperature is sufficient to condense the humidity of the air that passes through it,
      instant dewpoint temperature, displayed for example by a dewpoint transmitter or calculated by the controller by combining the temperature and humidity of the ambient air, for which a thermometer and a hygrometer are provided,
   b) external parameters, sent to the controller for example by internet:
      dewpoint temperature forecast in the following hours, in case of having access to the weather forecast, to calculate at which time of the day the litre of condensed water will be the cheapest in terms of energy,
      instant cost of electricity, in case of having access to the data of the electricity supply company, to be able to calculate together with the forecast dewpoint temperature which is the time of the day when the litre of condensed water will be the cheapest in economic terms,
      expected water demand, in case of knowing the historical hourly demand, in order to calculate whether it is possible to wait for cheaper moments of obtaining water or if, despite the economic and environmental price, it is necessary to start the thermodynamic cycles at medium or full power.
the upper lid of the assembly has been arranged in the form of a funnel so that it can collect the rainwater that falls on it, in such a way that the rainwater can be conveyed to the water collecting tray under the evaporator and proceed to its purification following the same stages as the water obtained by condensation, since rainwater has very similar physical-chemical and biological characteristics to condensed water. Additionally, the system can be equipped with a tank for rainwater collected from the roofs of adjacent houses to
the system has also been fitted with a rain sensor that stops the compression refrigeration cycle when it starts raining or when there is rainwater stored in its tank, as the condensation process consumes much more energy than the potabilization process, substantially reducing the cost of the litre of drinking water obtained.
there is also the possibility of using the large amount of heat released by the compressor and the compression cycle so that while the heat released is being cooled the system can distil, and therefore purify, a stream of non-drinking, contaminated or unhealthy water that could be brought to the machine from an outside source. In this configuration, the lower part of a tank prepared for this purpose has a heat exchanger that is immersed when the water to be purified is supplied, and the upper part has a lid that acts as a smooth and inclined surface, such as a glass, which collects and carries the condensed drops on its surface to the water collection tray under the evaporator of the compression cycle to finish its adaptation to human consumption following the same stages as the water obtained by condensation, since the water thus evaporated or distilled has very similar physical-chemical and biological characteristics to the water condensed from air humidity,
for equipment placed very close to homes there is a possibility that the cold and dry air coming out of the evaporator, instead of being directly conducted through the compression cycle condenser, may be diverted to a room in the home, so that it can be used as air conditioning. In this option or setup there will be between the evaporator and condenser a cold air diverter damper and a cold air fan that makes the outside air pass through the evaporator by depression, and be conducted into the house through a cold air duct,
for the same equipment located near houses there is also the possibility that the hot air coming out of the condenser can also be used to heat some interior rooms, such as a bathroom, sauna, etc., or to heat the domestic water tank used in the house, for example, for house showers. In this option, a hot air duct will be placed at the outlet of the compression refrigeration system that takes the air into the home.
in addition to supplying water at room temperature, the equipment also offers the possibility of supplying hot or cold water, by making use of the residual heat and cold released by the machine, thus avoiding the subsequent energy expenditure of having to thermally prepare the drinking water. For this purpose, there is a cold water tap to which the water flows after having passed through a coil located behind the compression refrigeration cycle evaporator from the second purification circuit of the machine, after having passed through the carbon filters, mineralization and second ultraviolet lamp. Similarly, there is a hot water tap fed by water that has passed through a coil located behind the condenser of the compression refrigeration cycle, also coming from the second purification circuit of the machine.

In this way, the following energy advantages or improvements are obtained and, therefore, economic advantages in terms of the cost of the litre of drinking water obtained:
to reduce the bypass factor and dry out the air further,
to drain the bottom of the evaporator, allowing new water drops to condense on its surface,
to make use of the free heat from the intense heat of the sun existing in the typical areas where the machine is installed to include a hybrid compression and absorption refrigeration system, using both instant information from the local weather and information forecast for the next following hours that are communicated to the machine via the Internet, which together with the data on the expected demand or regular consumption will allow the compression refrigerator to be connected or not, which has a much higher consumption of energy than the absorption refrigerator,
to allow the collection and purification of rainwater collected by the machine, and by any other surface such as the roofs of nearby buildings, making use of the existing purification system in the machine, which increases the production of drinking water with a minimum additional economic cost, even turning off the machine compressor when it starts raining or rainwater is available in its tank,
to make use of the large amount of heat released by the compressor and compression cycle in its refrigeration, so that at the same time the heat released distils and purifies non-drinking water at a minimum additional economic cost, since the machine's existing water purification system is also used afterwards,
to make use of the cold and dry air that passes through the evaporator to take it inside the house or nearby building to cool spaces and, in the same way, to conduct the heat that comes out of the condenser to heat interior spaces as needed,
to use also the residual cold and residual heat of the machine to cool or heat the water to be supplied to the users by means of separate hot and cold water taps.

### BRIEF DESCRIPTION OF THE DRAWINGS

To complement the description that is being made and in order to provide a better understanding of the characteristics of the invention, a set of drawings is attached hereto as an integral part of said description, where the following has been represented, including but not limited to:

FIG. 1. It shows the simple water condensing and potabilizing machine, where it can be seen that on a metal frame (1) there is a compression evaporator (2), an associated condenser (3), a compressor (4), a main fan (6) that forces the air to enter the machine. Under the evaporator there is a water manifold (9) that collects the condensed drops that are sent to a water tank (10) through a primary hydraulic pump (11) of the primary circuit, which makes it pass through some filters of sediments (13) and a first ultraviolet lamp (14). There is also a secondary hydraulic pump (12) from the secondary circuit that takes the water from the water tank (10) and makes it pass through a carbon filter (16) and a mineralizing filter (17) up to a water outlet tap (18). The equipment has an electrical system (7) and a simple control system (8) that manages the operation of the equipment.

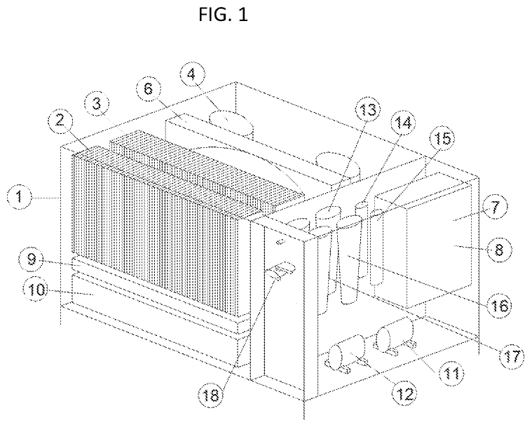

FIG. 2. It shows a diagram of the connection and operation of the two water circuits of the machine. Thus, it can be seen how in the primary circuit the water collected in the manifold (9) tray is driven by the primary hydraulic pump (11) through three sediment filters (13) of 20 μm, 10 μm and 5 μm, and a first ultraviolet lamp (14) until reaching the water tank (10). Here the secondary circuit starts, in which a secondary hydraulic pump (12) takes the water from the water tank (10) and passes it through a carbon filter (16), a mineralizing filter (17) and a second ultraviolet lamp (15) until it reaches the water outlet tap (18) for consumption. A water pressure sensor (19) and a pressure tank or hydro-pneumatic accumulation tank (20) are placed to maintain the circuit pressure. It can be seen how in order to regulate the amount of dissolved salts a bypass with an electrovalve (22) has been arranged around the mineralizing filter (17) that is regulated by a hardness sensor (23), a conductivity sensor or TDS. A pH sensor (27) is also shown in the secondary circuit. Finally, it can be seen how a water recirculation loop has been installed, and this water is taken from the water tank (10) by the secondary hydraulic pump (12) and thanks to an electrovalve (22) it is passed through the first ultraviolet lamp (14) of the primary circuit until it returns to the water tank (10).

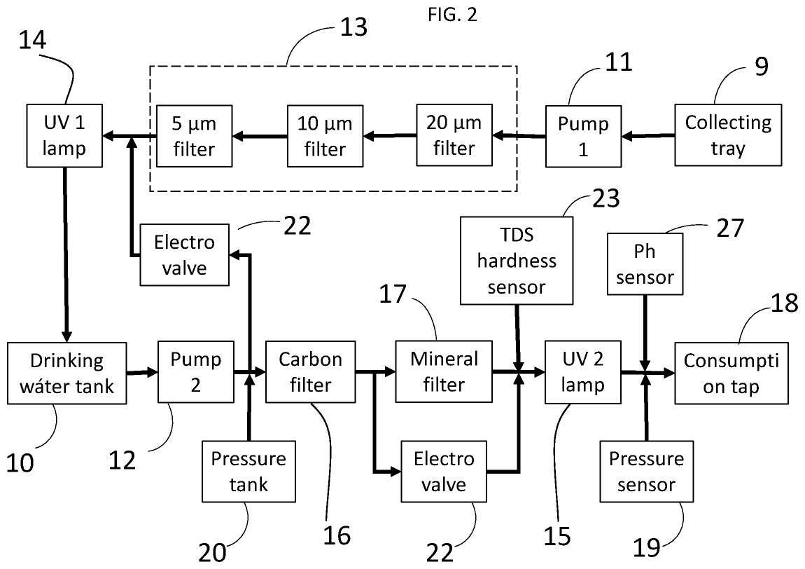

FIG. 3. It shows a machine like the one described in FIG. 1, which has an air filter (24) and an air ionizer (25) through which the air passes before entering the compression evaporator (2). Also shown is a CO₂ sensor (26) that measures the quality of the ambient air.

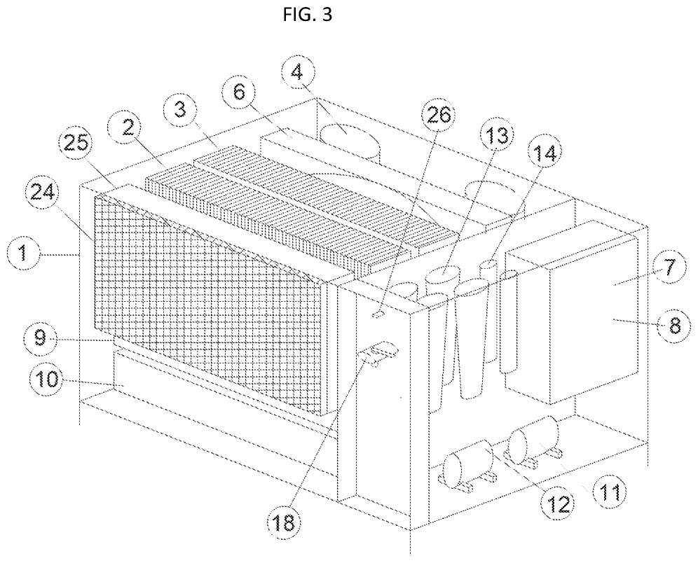

FIG. 4 and FIG. 4A. It shows a detail of the assembly formed by the compression evaporator (2), the condenser (3) and the water manifold (9) on which some perimeter plates (28) are assembled, forming a basin only open at the top where a disinfectant and descaling liquid can be poured to carry out the thorough cleaning of the compression evaporator (2) and condenser (3).

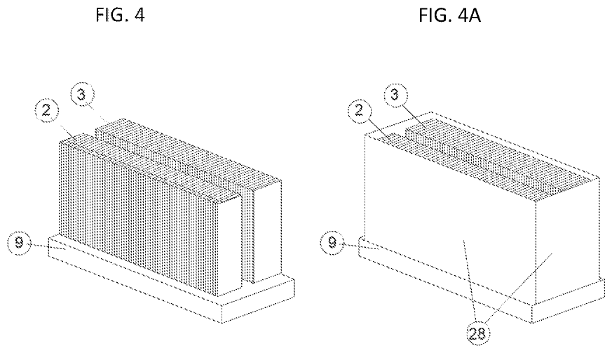

FIG. 5 and FIG. 5A. It shows a perspective and floor detail of the arrangement of some slats (29) of the compression evaporator (2) around some counterbalanced freon tubes (31), the latter part having a sinuous contour in the form of “S” as a drop-breaking profile (30).

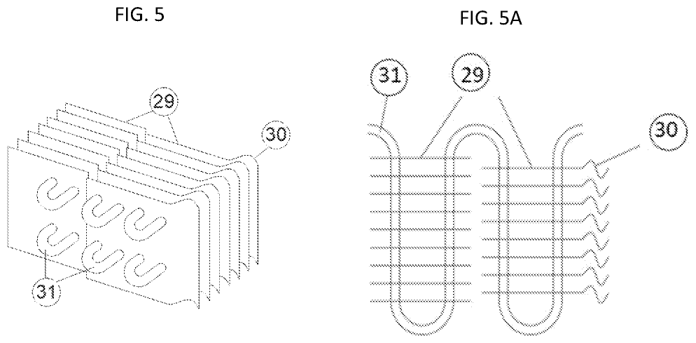

FIG. 6. It shows a machine like the one described in FIG. 1, which has a vibrator (32) physically attached to the compression evaporator (2) that provides a vibration that makes the drop of condensed water fall on the slats (29) of said evaporator, and an air compressor with a diffuser (33) that produces short and periodic impulses of pressurized air from the upper part of the compression evaporator (2) causing the drop of water to fall faster towards the water manifold (9).

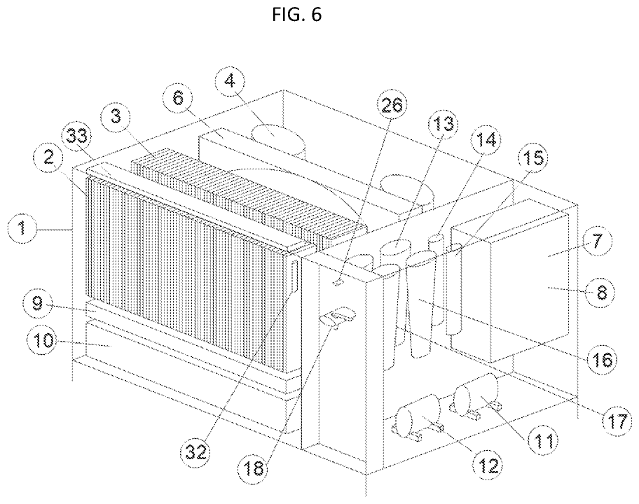

FIG. 7. It shows the condensing and potabilizing machine as described in FIG. 1 where it is possible to see the incorporation of an absorption evaporator (34), some solar thermal panels (35) or absorption condenser, and an absorption exchanger (36). In addition, sensors such as a hygrometer (37), a thermometer (38), a barometer (39) and a photometer (40) are included. In addition, an intelligent control system (41) with an Internet connection module (42).

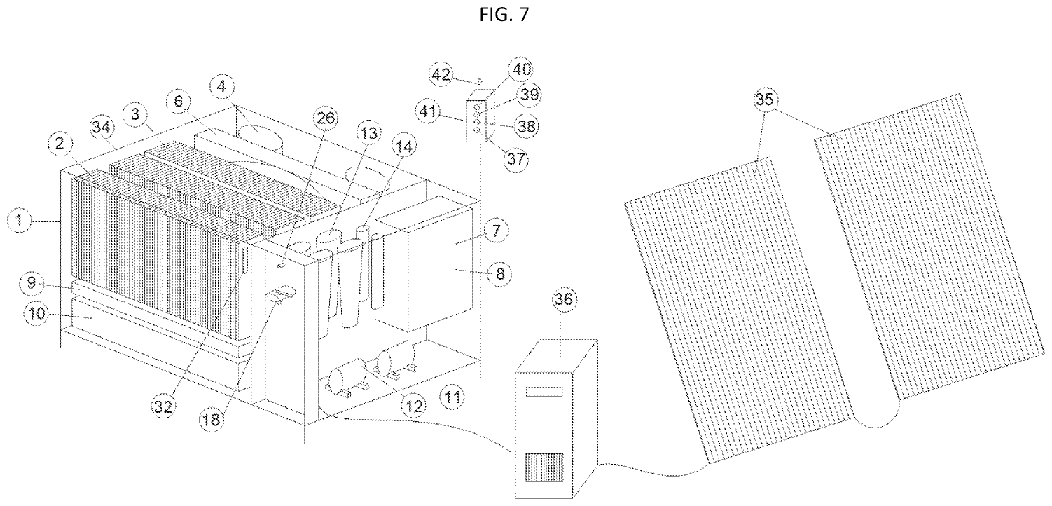

FIG. 8. It shows a condensing machine like the one described in FIG. 1, which has been fitted with a funnel-shaped lid (44) or top cover to collect rainwater, and a rain sensor (46).

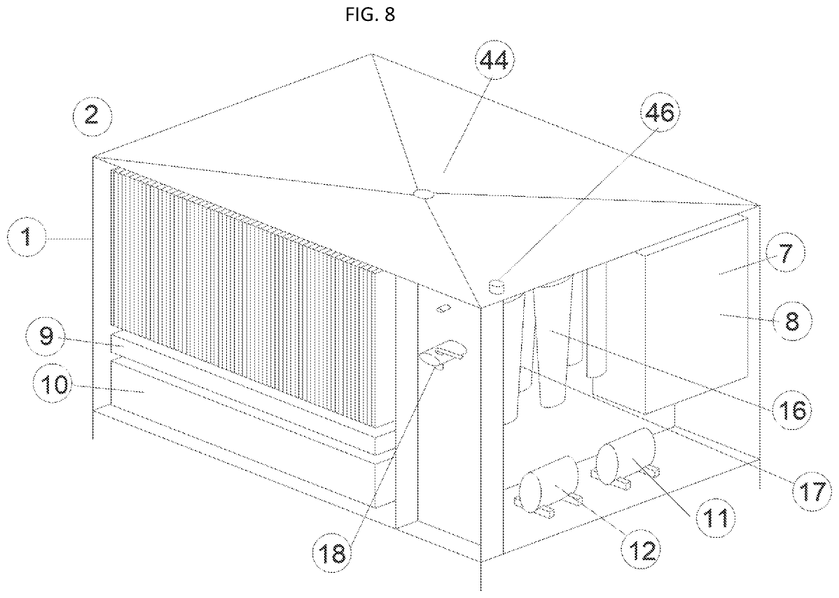

FIG. 9. It shows a non-drinking water tank (47) that has an immersed heat exchanger (48) that cools the compressor (4) and the thermodynamic cycle of the machine, which evaporates the water that is collected by an upper surface (49) condensing the distilled water that sends it to the collector (9) located under the compression evaporator (2).

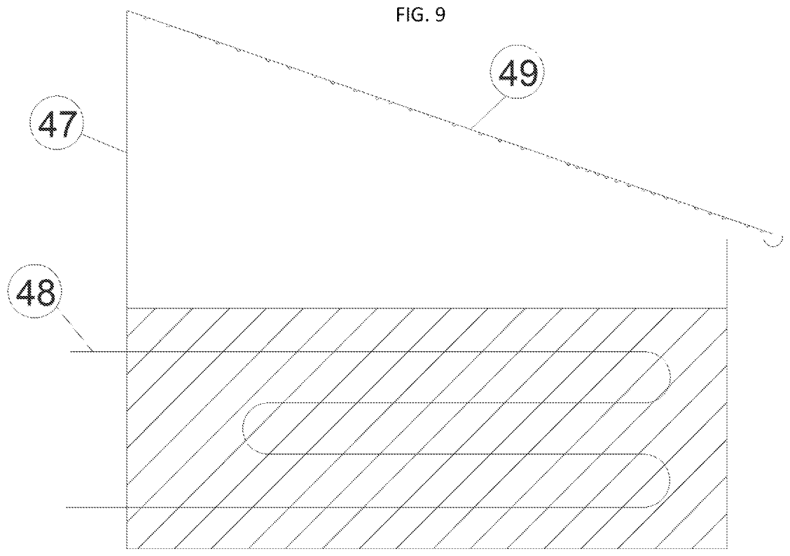

FIG. 10. It shows a condensing machine like the one described in FIG. 1 in which the cold and dry air that has passed through the compression evaporator (2) thanks to the depression caused by a secondary fan (51) is sent to the interior of the house through a secondary duct (52), and the hot air that passes through the condenser (3) by the action of the main fan (6) is sent to the interior of the house through a primary duct (53).

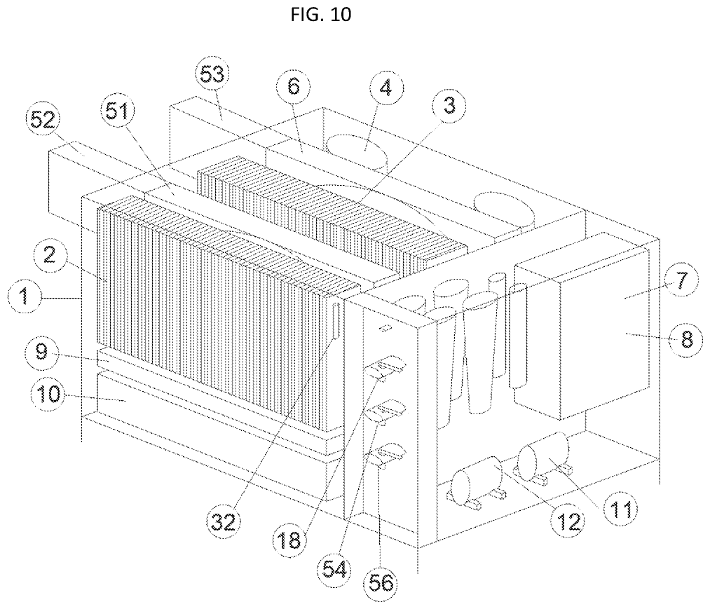

FIG. 11 and FIG. 11A It shows how a cold water tap (54) is fed by a pipe with a first coil (55) that is placed after the compression evaporator (2) of the machine and, at the same time, a hot water tap (56) is fed by a second coil (57) that is located behind the condenser (3) of the machine.

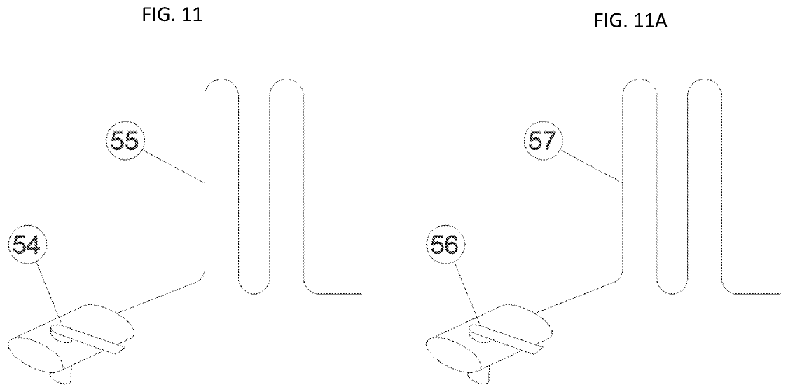

### PREFERRED EMBODIMENT OF THE INVENTION

The specific embodiment considered below is one of many that the present invention can adopt. The figures show how the assembly is formed by a metal frame (1) where most of the components of an optimized compression thermodynamic cycle are placed, such as a compression evaporator (2), a condenser (3), a refrigerant or heat-transfer fluid compressor (4), a rolling valve (5) and a main fan (6) that forces the air into the machine and an electrical system (7) and a control system (8) that manages the operation of the equipment. Thus, according to the invention:
under the compression evaporator (2) there is a water manifold (9) that collects the condensed drops that are sent to a water tank (10) through the primary circuit, formed by a primary hydraulic pump (11), which makes the water pass through some sediment filters (13) of 20 μm, 10 μm and 5 μm, and a first ultraviolet lamp (14). The equipment also has in place a secondary circuit, in which a secondary hydraulic pump (12) takes the water from the water tank (10) and passes it through a carbon filter (16), a mineralizing filter (17) and a second ultraviolet lamp (15) until it reaches a water outlet tap (18) for consumption. A water pressure sensor (19) and a pressure tank or hydro-pneumatic accumulation tank (20) are also placed to maintain the circuit pressure. In order to regulate the amount of dissolved salts it is fitted with a bypass around the mineralizing filter (17) with an electrovalve (22) that is regulated by a hardness sensor (23), a conductivity sensor or TDS, also having a pH sensor (27). It is also fitted with a water recirculation loop, and this water is taken from the water tank (10) by the secondary hydraulic pump (12) and thanks to an electrovalve it is passed through the first ultraviolet lamp (14) of the primary circuit until it returns to the water tank (10).
to improve the quality of the air entering the machine than from an air filter (24) and an ionizer (25) through which the air passes before entering the compression evaporator (2), as well as a CO₂ sensor (26) that measures the quality of the ambient air and warns the control system (8) of the machine to increase the pressure and speed of the primary hydraulic pump (11) in such a way that when it reaches the storage water tank (10) abruptly collides and bubbles, releasing part of the gases contained in it. In addition, the pH sensors (27) and the hardness sensor (23), the conductivity sensor or online TDS, check the quality of the water before it is consumed by users, preventing it from being supplied and warning the consumer of the unsuitability of drinking this water if it exceeds the limits set as acceptable due to the presence of unacceptable amounts of CO₂ dissolved in the water and considered as dangerous or harmful, this level having been established at 0.045% or 450 ppm, thanks to the research carried out for the development of this equipment, a level that is still healthy but from which the CO₂ fixation starts to be unacceptable for the developers of the invention.
to allow thorough cleaning of the heat exchangers the system is designed in such a way that on the water manifold (9) some watertight perimeter plates (28) can be assembled and disassembled so that they contain the compression evaporator (2) and the condenser (3), forming a basin only open at the top where a disinfecting and descaling liquid can be poured for a thorough cleaning by immersion,
in order to reduce the by-pass factor, some slats (29) of the compression evaporator (2) around freon tubes (31), are placed in a counterbalanced way to divide the air flow without noticeably increasing the load drop, with the last slat having been stamped with a sinuous “S” shape as a drop-breaking profile (30),
to prevent water from stagnating on the bottom of the compression evaporator (2) thus waterlogging it and preventing new water drops from condensing on it, a vibrator (32) has been installed that provides a vibration that makes the drop of condensed water fall on the evaporator slats, and an air compressor with a diffuser (33) at the upper part of the compression evaporator (2) that produces short and periodic impulses of pressurized air from the top of the evaporator causing the water drop to fall more quickly into the water collection tank (9),
the equipment can also have an absorption thermodynamic cycle to make use of the intense heat of the sun that is usually found in the climate zones that are the most suitable for this type of machine. This absorption cycle is assembled on the compression cycle, constituting a hybrid system that makes use of each of them and compensates for the respective disadvantages. The machine is accordingly equipped with an absorption evaporator (34) that is inserted between the compression evaporator (2) and the compression cycle condenser (3), some solar thermal panels (35) and an absorption exchanger (36). The water manifold (9) connected to the primary and secondary purification circuits is located under the evaporators in the same way. For its correct operation the assembly is equipped with different sensors such as a hygrometer (37), a thermometer (38), a barometer (39) and a photometer (40), which allows determining the suitability of connecting the absorption cycle and reducing the intensity of the compression cycle. In addition, an intelligent control system (41) has an internet connection module (42) to carry out an efficient control of the assembly, since in addition to the instant data from the local weather obtained by the sensors, the equipment uses the forecast for the following few hours that are communicated to the machine via the Internet, which together with the data on the expected demand or regular consumption of water and the level of stored water will allow the compression refrigerator to be connected or not, which has a much higher consumption of energy than the absorption refrigerator,
it also has the necessary elements to collect and purify rainwater, which falls into the machine on a lid (44) or top cover made in the form of a funnel or on any other surface such as the roofs of nearby buildings, making use of the existing purification system in the machine, which increases the production of drinking water with a minimum additional economic cost, even turning off the machine compressor when a rain sensor (46) detects that it starts raining or rainwater is available in a non-drinking water tank (47),
in addition, it has elements to make use of the large amount of heat that is residually released by the compressor (4) and the thermodynamic cycle in its refrigeration, so that through a heat exchanger (48) immersed in a non-drinking water tank (47) it evaporates or distils and purifies the water which is collected by an upper surface (49) condensing the distilled water that sends it to the manifold (9) located under the compression evaporator (2) of the system using the whole water purification system existing in the machine, since the water thus distilled and the water condensed by the machine have very similar characteristics,
in addition, there are in place systems to make use of the cold and dry air that passes through the compression evaporator (2) to take it into the interior of the home or nearby building to cool spaces, thanks to the depression caused by a secondary fan (51) that feeds a secondary cold air duct (52) that takes it to the place of consumption. Likewise, the hot air that passes through the condenser (3) by the action of the main fan (6) is sent to the interior of the house through a primary duct (53) to heat spaces as needed such as bathrooms or to heat the domestic water of the house,
similarly to the above, the machine can be equipped with elements to make use of the residual cold and residual heat of the machine to cool or heat the water to be supplied to users, making the water pass through a pipe with a first coil (55) at the rear of the compression evaporator (2) and sending this already cooled water to a cold water tap (54). In the same way, the water is led through a second coil (57) at the rear of the condenser (3) until it reaches a hot water tap (56) avoiding the energy cost of thermally conditioning the drinking water.

What is claimed is:

1. Air humidity condensing and potabilizing machine, of the type comprising a thermodynamic compression equipment that is fitted with a refrigerant or heat-transfer fluid compressor (4), a rolling valve (5) and an electrical system (7) and a control system (8) managing the operation of the equipment, and which is capable of forcing air through a compression evaporator (2) and a condenser (3) by means of main fans (6) that force the air into the machine, characterized in that it comprises:
a water collector (9) located under a compression evaporator (2), which collects the condensed drops that are sent to a water tank (10) through a primary circuit, where this primary circuit is formed by a primary hydraulic pump (11) that makes the water pass through sediment filters (13) of 20 μm, 10 μm and 5 μm and through a first ultraviolet lamp (14);
a secondary circuit, in which a secondary hydraulic pump (12) takes the water from the water tank (10) and makes it pass through a carbon filter (16), through a mineralizing filter (17) and through a second ultraviolet lamp (15) until it reaches a water outlet tap (18) for consumption;
a water pressure sensor (19) and a pressure tank or a hydro-pneumatic accumulation tank (20) that maintains the circuit pressure;
a bypass around the mineralizing filter (17) with an electrovalve (22) that is regulated by a hardness sensor (23), a conductivity sensor or TDS, as well as by a pH sensor (27); and
a water recirculation loop, which takes the water from the water tank (10) by the secondary hydraulic pump (12), and through an electrovalve (22) it is passed through the first ultraviolet lamp (14) of the primary circuit until it returns to the water tank (10).

2. Air humidity condensing and potabilizing machine, according to claim 1, comprising:
an air filter (24); an ionizer (25), through which the air passes before entering the compression evaporator (2); and a CO₂ sensor (26) that measures the quality of the ambient air in so that:
above a pre-set limit, the CO₂ sensor (26) warns the control system (8) of the machine that increases the pressure and speed of the primary hydraulic pump (11) in such a way that when the primary hydraulic pump (11) reaches the water tank (10), this water abruptly collides and bubbles releasing part of the gases contained in such primary hydraulic pump (11) and by means of the pH sensors (27) and the hardness sensors (23) the quality and acidity of the water is checked, until the CO₂ levels are back to adequate.

3. Air humidity condensing and potabilizing machine according to claim 2, where the pre-set threshold of the CO₂ sensor (26) is 0.045% or 450 ppm.

4. Air humidity condensing and potabilizing machine according to claim 1, comprising has a water manifold (9) on which some watertight perimeter plates (28) are assembled and disassembled with fixing means, so that these perimeter plates (28) contain the compression evaporator (2) and the condenser (3) inside forming a basin only open at the top.

5. Air humidity condensing and potabilizing machine according to claim 1, in which some slats (29) of the compression evaporator (2) are placed in a counterbalanced manner and are around freon tubes (31), the last slat (29) having an “S” shape as a drop-breaking profile (30).

6. Air humidity condensing and potabilizing machine according to claim 1, comprising a vibrator (32) that provides a vibration that makes the drop of condensed water fall on the slats (29) of the compression evaporator (2); and an air compressor with a diffuser (33) in the upper part of the compression evaporator (2) that produces short and periodic impulses of pressurised air from the upper part of said evaporator causing the water drop to fall faster into the water collection tank (9).

7. Air humidity condensing and potabilization machine according to claim 1, comprising:
a thermodynamic absorption cycle with an absorption evaporator (34) that is introduced between the compression evaporator (2) and the compression cycle condenser (3), where the condensed water is collected from the collecting tray (9);
solar thermal panels (35);
an absorption exchanger (36);
a hygrometer (37);
a thermometer (38);
a barometer (39);
a photometer (40); and
an intelligent control system (41) with an internet connection module (42) that receives weather forecast information, and that connects to the compression evaporator (2).

8. Air humidity condensing and potabilization machine according to claim 1, comprising:
a lid (44) or upper cover made in the form of a funnel, which collects the water falling on the machine or on any other surface and which conveys said water to the purification system existing in the machine; and
a rain sensor (46), which turns off the compression cycle of the machine when it detects rainwater in a non-drinking water tank (47).

9. Air humidity condensing and potabilizing machine according to claim 1, comprising a non-drinking water tank (47) with a immersed heat exchanger (48) that uses the residual heat released by the compressor (4) and other elements of the thermodynamic cycle in its refrigeration, to evaporate, distil and purify non-drinking water, which is collected by a condensing upper surface (49) that condenses the distilled water and is sent to the water purification system existing in the machine.

10. Air humidity condensing and potabilization machine according to claim 1, comprising:
a secondary fan (51) placed behind the condenser (3) that feeds a secondary duct (52) for evacuating or transmitting the cold air; and
a primary duct (53) for evacuating or transmitting the hot air fed by the main fan (6) located behind the condenser (3);
in such a way that the residual cold and hot air that leaves the compression evaporator (2) and the condenser (3), respectively, are diverted, conducted and used.

11. Air humidity condensing and potabilization machine according to claim 1, comprising:
a first coil (55) of drinking water that is located at the rear of the compression evaporator (2), which is residually cooled by the cold air passing through it, and which feeds a cold water tap (54); and
a second coil (57) of drinking water that is located at the rear of the condenser (3), which is residually heated by the hot air passing through it, and which feeds a hot water tap (56).
